(19) United States
(12) Patent Application Publication
(10) Pub. No.: US 2025/0217914 A1
(43) Pub. Date: Jul. 3, 2025

(54) USER READINESS EVALUATION SYSTEM

(71) Applicant: AdaptivEdge Readiness Technologies, LLC, Dallas, TX (US)

(72) Inventors: Jack LANDERS, Plano, TX (US); Brad BELLETTO, Dallas, TX (US)

(21) Appl. No.: 19/003,863

(22) Filed: Dec. 27, 2024

Related U.S. Application Data
(60) Provisional application No. 63/615,703, filed on Dec. 28, 2023.

(51) Int. Cl. G06Q 50/20; G06F 40/30

(52) U.S. Cl. CPC G06Q 50/2057; G06F 40/30

(57) ABSTRACT

A method, computer system, and computer program product are provided for performing user evaluations. An evaluation module is retrieved from a data repository. The evaluation module comprises a set of questions. Each question is presented with a number of answer choices in a graphic user interface. Each answer choice is associated with a respective confidence slider. Each confidence slider is operable to receive an input representing a user's confidence in an associated answer choice. A confidence factor is generated for each answer choice based on a position of the respective confidence slider for the associated answer choice. A weighted score is calculated for the question by scaling a question score by the confidence factor associated with a correct answer to the question. A report is generated based on the weighted score and the confidence factor associated with the correct answer.

### CROSS-REFERENCE TO RELATED APPLICATIONS

This application claims the benefit of U.S. Provisional Application Ser. No. 63/615,703, filed Dec. 28, 2023, which is hereby incorporated by reference for all purposes.

### BACKGROUND

Employee training systems are tools for developing a competent and knowledgeable workforce. Employee training systems provide structured learning experiences designed to enhance the skills and knowledge of employees, tailored to meet the specific needs of their roles within an organization. These systems range from traditional in-person training sessions to sophisticated digital platforms that deliver a variety of interactive e-learning courses.

With the advent of technology, employee training systems have evolved significantly. Modern systems are often integrated with Learning Management Systems (LMS) that enable the delivery, tracking, and management of training programs online. LMS utilize multimedia content like videos, simulations, and gamified elements to engage learners, making the training process more interactive and effective.

The deployment of such systems can be seen across industries, addressing a wide array of learning objectives, from onboarding new hires and upskilling current employees to ensuring compliance with industry regulations. The capability to track and assess progress through quizzes, assessments, and real-time feedback is a key feature of these systems, allowing both employees and employers to monitor and measure the effectiveness of the training provided.

Training systems often leverage data analytics to personalize learning experiences and provide recommendations for future learning paths, helping to build a culture of continuous improvement and learning. The goal is to create a dynamic learning environment that adapts to the changing needs of the workforce and the organization.

### SUMMARY

The embodiments herein provide for a method, computer system, and computer program product are provided for performing user evaluations. In one embodiment, a method for performing a user evaluation includes retrieving an evaluation module from a data repository. The evaluation module comprising a set of questions. The method further includes presenting a question with a number of answer choices in a graphic user interface. Each answer choice is associated with a respective confidence slider. Each confidence slider is operable to receive an input representing a user's confidence in an associated answer choice. The method additionally includes generating a confidence factor for each answer choice based on a position of the respective confidence slider for the associated answer choice. The method also includes calculating a weighted score for the question by scaling a question score by the confidence factor associated with a correct answer to the question. The method further includes generating a report based on the weighted score and the confidence factor associated with the correct answer.

Other aspects of the invention will be apparent from the following description and the appended claims.

### BRIEF DESCRIPTION OF DRAWINGS

FIG. 1 shows a block diagram for an evaluation system according to one or more illustrative embodiments.

FIG. 2 shows a flow chart according to one or more illustrative embodiments.

FIG. 3 shows a method for performing a user evaluation according to illustrative embodiments.

FIGS. 4A, 4B, 4C, 4D and 4E show a graphical user interface according to one or more illustrative embodiments.

FIGS. 5A and 5B show a report according to one or more illustrative embodiments.

FIGS. 6A and 6B show a quantized categorization according to one or more illustrative embodiments.

FIGS. 7A and 7B show a computing system in accordance with one or more embodiments of the invention.

Like elements in the various figures are denoted by like reference numerals for consistency.

### DETAILED DESCRIPTION

In general, embodiments are directed to a training and learning assessment system providing personalized and targeted employee development. By leveraging advanced analytics and machine learning, it adjusts training content in real time, offering a bespoke experience that responds to the user's progress and confidence levels.

Such a system acknowledges the diverse backgrounds and learning styles of employees, ensuring that those needing more time to comprehend complex topics are not rushed, while those who grasp concepts quickly can advance without being held back. This not only enhances learning efficiency but also improves engagement, as employees are neither bored by ease nor overwhelmed by difficulty.

The system integrates confidence assessment tools to further refine the learning process. By capturing how confident employees feel about their answers, the system provides a dual-layered insight-what employees know and how confident they are in that knowledge. This information allows for targeted interventions by quickly identifying areas where confidence does not match competence.

The system may generate detailed reports and analytics that offer actionable insights into workforce capabilities and training efficiency. Skill gaps and strengths can be quickly identified across teams, enabling data-driven decisions for future training investments, and aligning employee development with organizational goals.

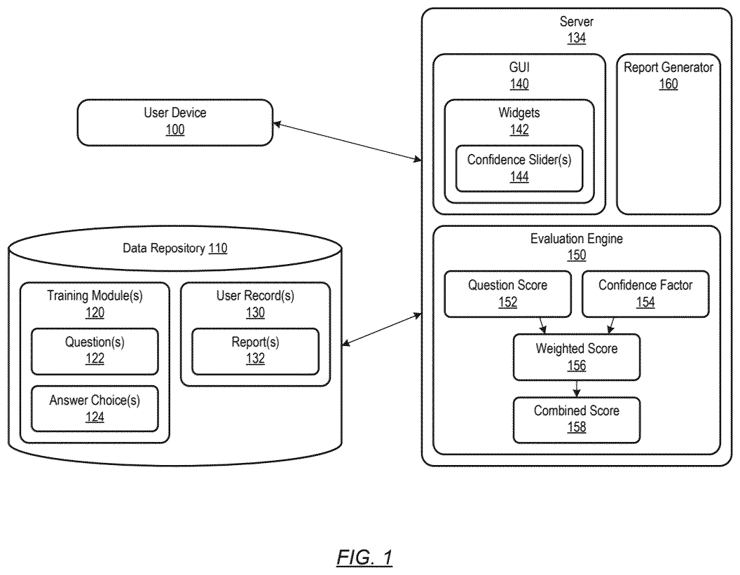

Turning to FIG. 1, a block diagram for an evaluation system is shown according to one or more illustrative embodiments. The system diagram depicts an employee training and evaluation system. The system is designed to not only evaluate the user's knowledge but also to gauge their confidence in the subject, topics, or material, allowing for a more comprehensive understanding of the user's true readiness and areas that may require additional review, coaching, training, or remediation.

The user device (100) is the access point for users to interact with the evaluation system. The user device (100) encompasses any computational hardware utilized by an individual to access and interact with digital training content. Suitable examples include desktop computers with Ethernet connectivity, laptops with Wi-Fi capabilities, smartphones, and tablets with 4G/5G and Bluetooth support, and smart wearables with NFC technology. The user device (100) may support various data communication protocols such as TCP/IP for networking and HTTPS for secure data transmission. These devices are typically equipped with processors capable of handling multimedia content, displays for visual output, speakers for audio, and inputs such as keyboards, touchscreens, or voice recognition for user interaction. The user device (100) may be configured to run a spectrum of operating systems such as Windows, MacOS, Linux, iOS and Android that support an array of applications necessary to render and interact with the training modules, leveraging libraries and formats such as HTML5, CSS3, and JavaScript for web-based modules, or specialized applications for platform-specific content.

In one or more embodiments of the invention, the data repository (110) is any type of storage unit and/or device (e.g., a file system, database, data structure, or any other storage mechanism) for storing data. Further, the data repository (110) may include multiple different, potentially heterogeneous, storage units and/or devices.

The data repository (110) represents a centralized storage system designed to house and manage digital information and may be specifically tailored for educational and training environments. It comprises databases and file storage systems configured to maintain a variety of content types, including multimedia training modules, text-based questions, and multiple-choice answer options. This repository supports structured query language (SQL) for relational databases or uses NoSQL for more flexible data models, catering to dynamic content storage needs.

On the hardware end, the data repository (110) is implemented on robust server infrastructures with high storage capacity, often employing solid-state drives (SSDs) for faster data retrieval and hard disk drives (HDDs) for larger archival storage. The repository is typically managed by data management software that ensures data integrity, security, and backup, with redundancy systems like RAID configurations for fault tolerance. The implementation of this component ensures scalability and performance optimization, crucial for supporting a growing number of users and increasingly complex data sets.

Training module(s) (120) are a collection of curated instructional materials designed for the purpose of skill development and knowledge enhancement. These modules encompass interactive multimedia content such as videos, animations, graphics, and text, which are often packaged using e-learning standards like SCORM or xAPI to track and report user progress. The modules are engineered to be compatible across various devices and platforms, using responsive design principles and HTML5 technology for seamless user experiences. The modules may also incorporate simulations, quizzes, and interactive scenarios, requiring the use of JavaScript, CSS, and HTML canvases for dynamic interactivity. The design of these modules supports modular architecture, allowing for incremental updates and scalability to facilitate evolving educational needs.

Question(s) (122) are a set of interactive queries formulated to evaluate the understanding and retention of information by a user engaging with the training module(s) (120). These questions are designed to be adaptive, potentially varying in complexity based on the user's progress and performance. The questions may be stored in a variety of formats, such as XML, YAML or JSON, which allows for interoperability with different e-learning platforms and facilitates easy updates or modifications to the question set. The structure of these questions is intended to be compatible with e-learning standards like SCORM or xAPI, enabling the tracking and reporting of detailed analytics on user responses.

Answer choice(s) (124) are predefined selections available to the user in response to question(s) (122). These choices are typically structured in a multiple-choice format, where each question is associated with several answer choices, only one of which is correct or most appropriate. Answer choices may be stored in a variety of formats, such as XML, YAML or JSON, which allows for interoperability with different e-learning platforms and facilitates easy updates or modifications to the question set.

The user record(s) (130) in this system serve as a digital ledger of each user's interactions with the training modules. This data collection comprises records of user identities, their progress through different modules, responses to questions, selections of answer choices, and any assessments or scores achieved. These records are typically formatted in a structured data format such as SQL for relational databases or JSON for document-oriented databases, facilitating ease of access, querying, and reporting. The records are securely stored, with encryption and access controls implemented to protect user privacy and comply with data protection regulations. The storage of user record(s) is scalable to accommodate an increasing number of users and utilizes redundancy and backup protocols to ensure data preservation.

Report(s) (132) are compiled documents or outputs that synthesize user interaction data and assessment outcomes from the training modules. These reports are generated in formats such as PDF, HTML, or Excel spreadsheets for ease of distribution and analysis. Technically, report(s) (132) encompass various data visualizations, such as charts and graphs, to convey user performance metrics, learning progress, and potential areas for improvement. Advanced reporting features may include data filters, aggregation functions, and custom report templates, facilitated by reporting software or libraries like Tableau, JasperReports or Crystal Reports. The generation of these reports is supported by server-side scripting and scheduled tasks for periodic updates, requiring robust server hardware with adequate processing power to manage complex data compilation tasks.

Server (134) functions as the central processing and management hub for the evaluation system. It is equipped with high-performance hardware, including multi-core processors and substantial RAM, to manage concurrent user requests and data processing tasks efficiently. The server operates on a server operating system like Linux or Windows Server, providing a stable and secure environment for running server-side applications and services. It supports various communication protocols, including HTTP/HTTPS for web traffic and WebSocket, HTTP2 and gRPC for real-time communication. The server hosts a range of software components, such as a web server (e.g., Apache or Nginx), a database management system (e.g., MySQL, PostgreSQL), and application servers for executing business logic. Additionally, it includes security features like firewalls and SSL/TLS encryption to safeguard data transmission and access control systems to manage user authentication and authorization. The server architecture is designed for scalability, enabling it to accommodate increased load and to integrate seamlessly with cloud services for additional computational resources or data storage.

The graphic user interface (GUI) (140) is a visual interface that enables user interaction with the evaluation system. Constructed using HTML5, CSS3, and JavaScript, it ensures compatibility across various devices and browsers. The graphic user interface (GUI) (140) includes elements like interactive menus, buttons, and confidence sliders, designed for user-friendliness and accessibility. It may incorporate responsive design principles, allowing it to adapt to different screen sizes, from desktop monitors to mobile devices. Advanced JavaScript frameworks, such as React or Angular, are employed to enhance interactivity and user experience. AJAX technology is used for smooth, asynchronous data loading, improving the interface's responsiveness.

Widgets (142) are discrete interface elements embedded within the graphic user interface (GUI) (140) that facilitate specific user interactions or display information in a dynamic and interactive manner. These widgets are typically developed using a combination of HTML, CSS, and JavaScript, ensuring seamless integration within the GUI. Common examples include drop-down lists, progress bars, interactive charts, and custom sliders, each providing a unique functionality such as data input, navigation, or visual representation of complex data sets. For enhanced interactivity and dynamic content display, AJAX calls might be used within these widgets to fetch and update data without needing to reload the entire page. The design of these widgets is focused on user experience, ensuring that the widgets are intuitive, accessible, and responsive to various device screens.

The confidence slider(s) (144) are interactive components designed to capture a user's confidence level in their responses within the evaluation system. These sliders are implemented using HTML for structure, CSS for styling, and JavaScript for dynamic interaction, ensuring confidence slider(s) are responsive and functional across various devices and screen sizes. The slider allows users to indicate their level of confidence on a scale, typically ranging from low to high. The technical implementation includes event handlers to detect user interaction and capture the chosen confidence level. This data is then processed to influence the scoring or feedback mechanism of the evaluation system.

The evaluation engine (150) is software designed to analyze and interpret user interactions and responses within the evaluation system. It is built using advanced programming languages like Python, PHP, or Java, leveraging algorithms and logic to calculate scores and assess user performance. The evaluation engine (150) includes functionalities for processing user responses to questions, integrating confidence levels indicated by users, and generating a composite score that reflects both knowledge and certainty.

Internally, the evaluation engine employs algorithms that weigh user answers and confidence levels, using a scoring system that may involve statistical methods or machine learning techniques to provide nuanced assessments. The evaluation engine may integrate libraries for data processing and analysis, such as NumPy or Pandas in Python, facilitating efficient handling of large datasets. The evaluation engine is designed to operate in real-time, providing immediate feedback to users.

The question score (152) is a metric generated by the evaluation engine (150) to quantify a user's performance on specific questions within the evaluation system. This score is calculated based on the accuracy of the user's responses to questions in the training modules. The methodology for scoring might include simple point allocation for correct answers or more complex algorithms that consider the difficulty level of each question. Question score (152) is utilized as a key data point in assessing the user's knowledge and understanding of the training content. It forms a part of the overall evaluation of the user's performance and is instrumental in generating comprehensive reports and feedback. This data can be used to identify areas where the user might need further training or reinforcement.

The confidence factor (154) is a metric that quantifies a user's self-reported confidence in their answers to the evaluation system's questions. This factor is derived from the user's input on the confidence slider(s) (144), where the user indicates the level of certainty about their responses. This self-assessment metric is typically represented on a numerical scale, varying from low confidence to high confidence.

The confidence factor (154) adds a layer of depth to the user's performance assessment. The confidence factor is not only used to adjust the weight of the question score (152) but also provides insights into the user's self-perceived mastery of the content. This data may enable tailoring the training program to address areas of uncertainty or lack of confidence, thereby enhancing the overall effectiveness of the training experience.

The weighted score (156) is a composite metric calculated by combining the question score (152) with the confidence factor (154). The score is generated by applying a weighting algorithm, where the question score is adjusted based on the user's expressed confidence level. For example, a correct answer with high confidence will receive a higher weighted score than a correct answer with low confidence. The purpose of the weighted score is to provide a more nuanced assessment of a user's confidence, giving a holistic view of their understanding and mastery of the training content. This score enables evaluating the effectiveness of the training program and for tailoring future training to the user's specific needs.

The combined score (158) is an aggregate data point generated by the evaluation engine (150) to provide a comprehensive evaluation of a user's performance in the evaluation system. This score amalgamates various aspects of user interaction and assessment, including the weighted score (156) which integrates both the question score (152) to calculate the confidence factor or rating. (154). The combined score might also factor in additional elements like the time taken to answer questions, the progression through training modules, and the improvement in knowledge retention, recall, confidence, and improved performance over time.

For example, if a user indicates high confidence in an incorrect answer, the combined score reflects this discrepancy, indicating areas where the user needs more reassurance or understanding. Conversely, high confidence coupled with high accuracy would result in a high combined score, signaling a strong grasp of the material.

The primary use of the combined score is to provide a holistic view of a user's learning journey, encompassing not just what is known, but also how confident the user regarding the subject matter. This data may enable personalized feedback, guiding future training paths, and for administrators or trainers to understand the effectiveness of the training modules. The combined score allows for a more tailored learning experience, addressing specific user needs and fostering a deeper understanding of the material. Additionally, use of the combined score in user evaluations may reduce initial training time and material costs, expedite user time to competency, and enabling insight into areas where mistakes may be made on the job when misunderstandings are identified after completing the assessment.

The report generator (160) is software designed to compile and present data from user interactions and assessments within the evaluation system. It extracts and processes data such as combined scores, user progress, and confidence metrics to generate comprehensive reports. These reports are presented in formats like PDF, HTML, or Excel, facilitating easy sharing and analysis. The report generator utilizes libraries like Apache POI for Excel report generation, or Tableau Google Analytics, JasperReports for complex data visualization. It supports automated report generation, scheduling features, and customizable report templates, allowing for flexibility in how data is presented. The software is optimized for performance, ensuring efficient data processing even with large data sets, and is scalable to accommodate growing reporting needs.

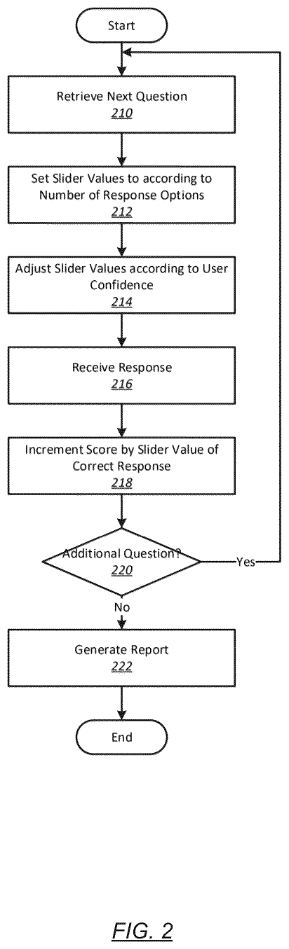

Turning to FIG. 2, a flow chart is shown according to one or more illustrative embodiments. The flow chart of FIG. 2 illustrates the operational steps of an evaluation system's process for interacting with a user during a training assessment.

At Block (210), system initiates a session and retrieves the next question for the user. Question retrieval may involve querying a database or content management system using SQL or similar query languages (like an AJAX API call) to select the appropriate question based on the user's current position within the module.

At Block (212), the system configures the confidence slider(s) based on the response options available for the current question. Configuration of the sliders may utilize a dynamic UI rendering process where the slider is adjusted in real-time using JavaScript to reflect the number of options.

At Block (214), the user interacts with the confidence slider(s) to indicate their confidence level in their response. This input may be captured through event listeners in the GUI, with JavaScript managing the slider value changes.

At Block (216), the system receives the user's answer (response?) to the question. This data transfer may be facilitated through an AJAX call to ensure that the response is transmitted to the server asynchronously without reloading the page.

At Block (218), the system increments the user's score based on the correctness of the response and the indicated confidence. Back-end logic, written in a server-side language like Python, PHP, Golang or Java, calculates the new score.

At Block (220), the system decides whether to retrieve another question based on predefined criteria, such as the number of questions in the module or if the user has met certain learning objectives. If the criterion for additional questions is met (“yes” at block 220), the system returns to Block (210).

At Block (222), upon completion of the questions, the system generates a report. The report can be generated using report generation libraries, which could include data visualization tools, such as graphs, tables, and/or charts, to summarize the user's performance.

Thereafter, the process concludes, and the user's session is terminated. Results may be stored in the user's record for future reference or analysis.

While FIGS. 1-2 show a configuration of components, other configurations may be used without departing from the scope of the invention. For example, various components may be combined to create a single component. As another example, the functionality performed by a single component may be performed by two or more components.

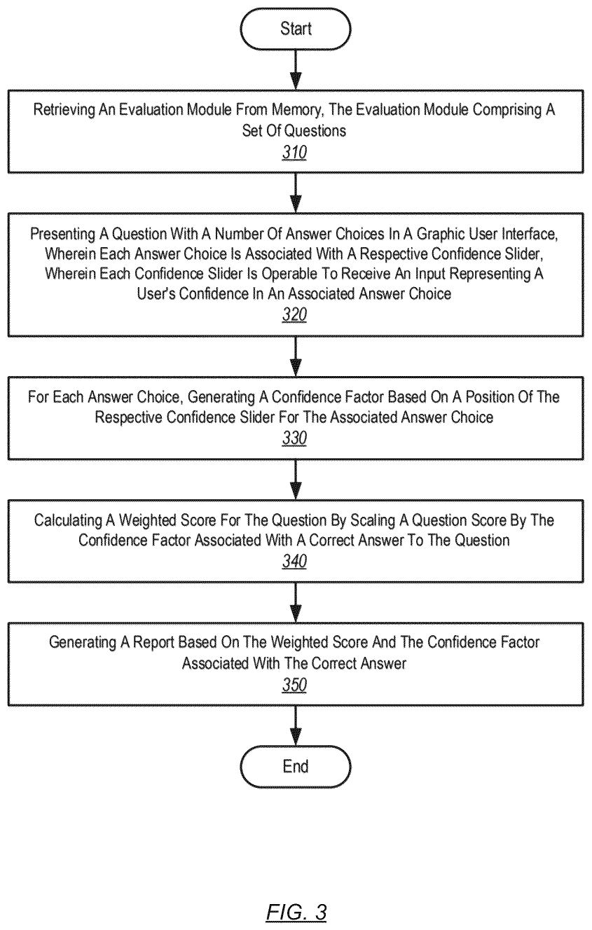

Turning to FIG. 3, a method for performing a user evaluation is shown according to illustrative embodiments. The method of FIG. 3 can be performed using one or more components of the system in FIG. 1, such as graphic user interface (GUI) (140) and evaluation engine (150).

At Block (310), an evaluation module is retrieved from a data repository. The evaluation model comprises a set of questions.

At Block (320), a question with a number of answer choices is presented in a graphic user interface. Each answer choice is associated with a respective confidence slider, wherein each confidence slider is operable to receive an input representing a user's confidence in an associated answer choice.

At Block (330), a confidence factor is generated for each answer choice. The confidence factor is based on a position of the respective confidence slider for the associated answer choice.

In some embodiments, generating the confidence factor for each answer choice may include normalizing confidence factors across the number of answer choices based on relative positions of each confidence slider. This normalization process may involve adjusting the confidence factors for each answer choice to ensure proportional representation of the user's confidence levels, relative to one another. The normalization may be performed by algorithms capable of calculating relative distances or positions of slider controls within the GUI. These algorithms would function to translate the slider positions into normalized numerical values, ensuring that the confidence expressed across multiple answers is comparative and proportionate.

At Block (340), a weighted score for the question is calculated by scaling a question score by the confidence factor (or average) associated with a correct answer to the question.

At Block (350), a report is generated based on the averaged/weighted score and the confidence factor associated with the correct answer.

In some embodiments, generating the report may include generating a quartile categorization of the confidence factor associated with the correct answer to the question, and presenting the quartile categorization in a chart and/or graph displayed in the graphical user interface.

For example, the report generator (160) takes the confidence factor associated with the correct answers and categorizes it into quartiles. This process would involve statistical analysis functions to divide the range of confidence factors into four equal parts, determining where each confidence factor falls within these parts. The graphic user interface (GUI) (140) then presents this categorization in a visually interpretable chart, aiding users to quickly understand the distribution of confidence factors. The chart could be rendered using graphical libraries like D3.js or Chart.js, integrated within the GUI to display data-driven visualizations.

In some embodiments, generating the report may include providing recommendations for further training based on a set of user records stored in the data repository. The recommendation comprises one or more additional modules based on a user's demonstrated knowledge and confidence levels as indicated in the report.

For example, the system, specifically the report generator (160), analyzes the user's performance and confidence levels as indicated in the report. It does this by accessing the user record(s) (130) stored in the data repository (110) to review past responses, scores, and confidence levels Based on this analysis, the system determines areas where the user has knowledge gaps or low confidence. It then recommends further training modules, which are selected to specifically address these areas. This step may utilize algorithms that match user performance metrics against a catalog of available training modules within the data repository (110), identifying those that best fit the user's needs for additional learning or skill reinforcement.

In some embodiments, the method may further comprise presenting a sequence of questions selected from the set of questions. For example, the server (134) may select and sequence questions, which may be algorithmically determined based on user progression, performance, or predefined criteria. Weighted scores for each respective question in the sequence are calculated, which may involve taking the raw score for a question and adjusting it based on the user's input from the confidence slider(s) (144) to reflect their confidence in their answer choice. Weighted scores for each question in the sequence are then combined to determine a combined score for the evaluation module. The combined score represents a user's overall mastery of subject matter in the evaluation module that may be used to assess the user's readiness or identify areas for improvement and is stored in the user record(s) (130). The report generator (160) could then use this combined score to create detailed reports for users or trainers to review.

In some embodiments, calculating the combined score may include incrementing the combined score based on the weighted score calculated for an associated question at each respective step of the sequence. For example, the combined score, which tracks the user's overall performance, is then incremented by this weighted score. The evaluation engine continually updates the combined score, through in-memory data handling and real-time calculations.

Based on the combined score, presentation of subsequent questions in the evaluation module may be adjusted\, for example by modifying question difficulty, reordering questions in the sequence, and adjusting the number of questions presented. The adjustments may be made manually, or dynamically managed by the server (134). For example, the server (134) may utilize the user record(s) (130) to store ongoing performance data and the graphic user interface (GUI) (140) to implement the adjustments in real-time. The logic for adjusting the presentation could be based on algorithms designed to provide adaptive learning experiences, and it would involve modifying the database queries to the data repository (110) and retrieving the subsequent questions and their associated answer choices.

In some embodiments, the method may further include storing the report in the data repository as part of a set of user records. The user records may include at least one of user demographics, job role, performance metrics, and training history.

For example, upon generation, the report generator (160) saves the report into the data repository (110). This step may involve creating or updating a record within the repository's database, which would be conducted using SQL commands if it is a relational database, or appropriate API calls for non-relational systems. The saved report is added to an existing set of user records, which could include a variety of user-specific data such as demographics, job role, performance metrics, and training history.

In some embodiments, the method may further include generating real-time analytics based on the weighted score, the confidence factor and a set of user records stored in the data repository to assess effectiveness of the evaluation module. The real-time analytics are then displayed in the graphic user interface to support decision-making processes related to employee training and development.

In some embodiments, the method may further include receiving additional content, including at least one of text, images, and multimedia. The additional content and the set of user records may be input into a large language model, where additional evaluation modules may be automatically generating from the additional content. The additional evaluation modules may be tailored to a user's demonstrated knowledge and confidence levels as indicated in the set of user records.

In this example, the system is designed to receive added content for training purposes, which can include text documents, images, videos, or other multimedia elements. Content may be received using file upload interfaces within the graphic user interface (GUI) (140) or integrations with external content management systems.

The received content, along with existing user records from the data repository (110), is inputted into a large language model. The input could utilize APIs to interface with the language model, providing the context needed to generate relevant materials.

The input data, the language model synthesizes new evaluation modules. These modules are tailored to the user's known knowledge and confidence levels, which are extracted from the user records. This step ensures that the content is personalized, providing an adaptive learning experience that targets the user's specific educational needs.

While the various steps in this flowchart are presented and described sequentially, at least some of the steps may be executed in different orders, may be combined, or omitted, and at least some of the steps may be executed in parallel. Furthermore, the steps may be performed actively or passively.

The following example is for explanatory purposes only and not intended to limit the scope of the invention.

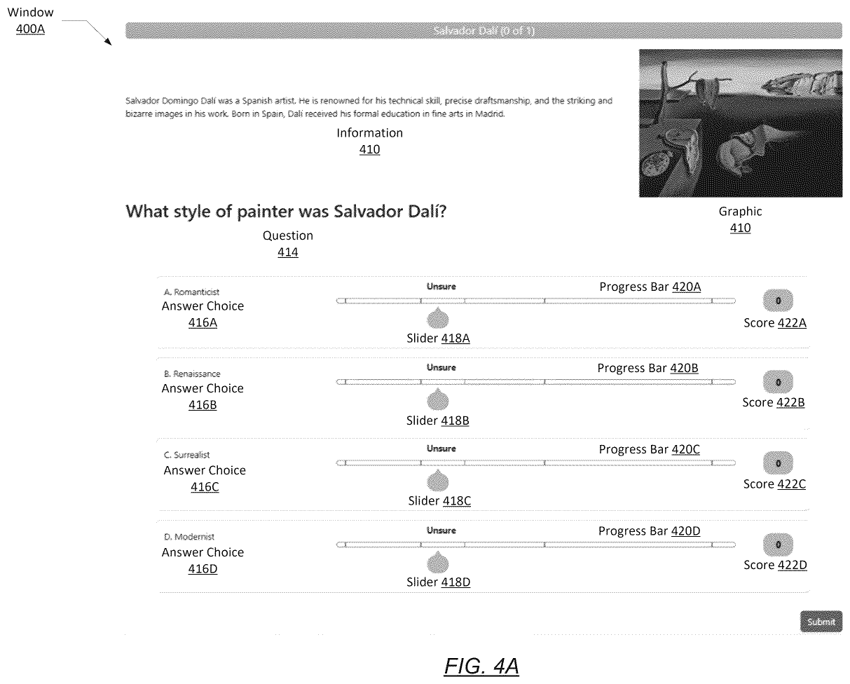

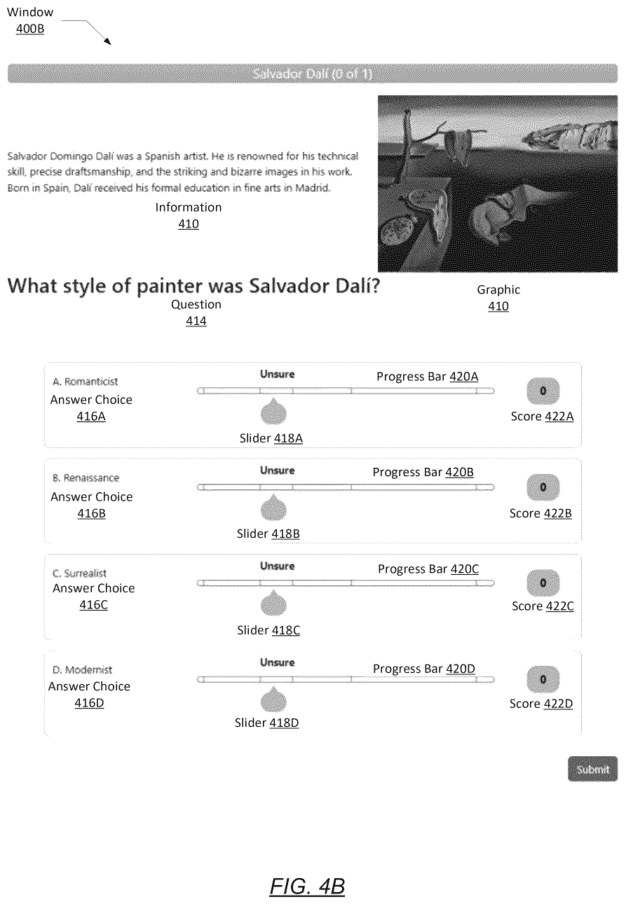

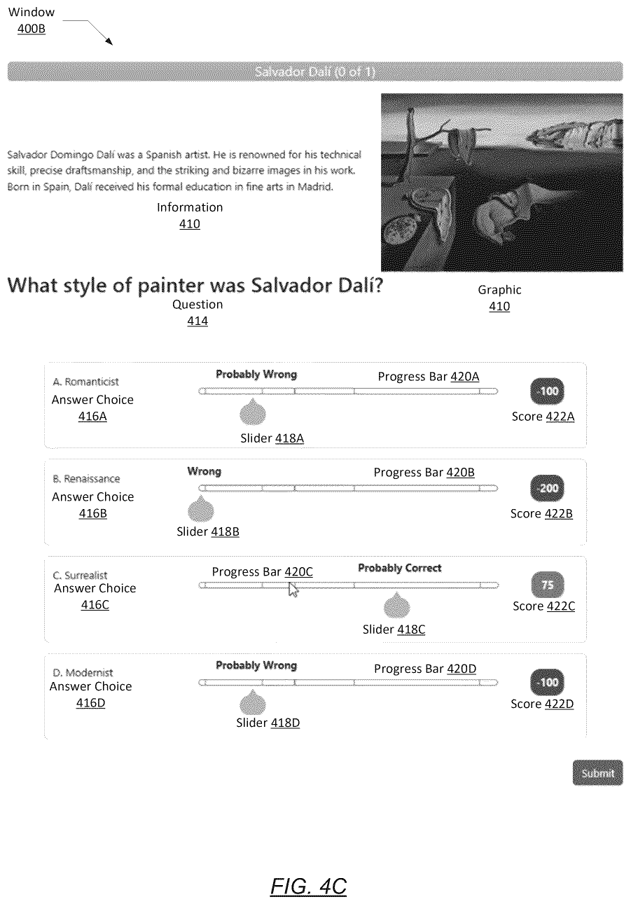

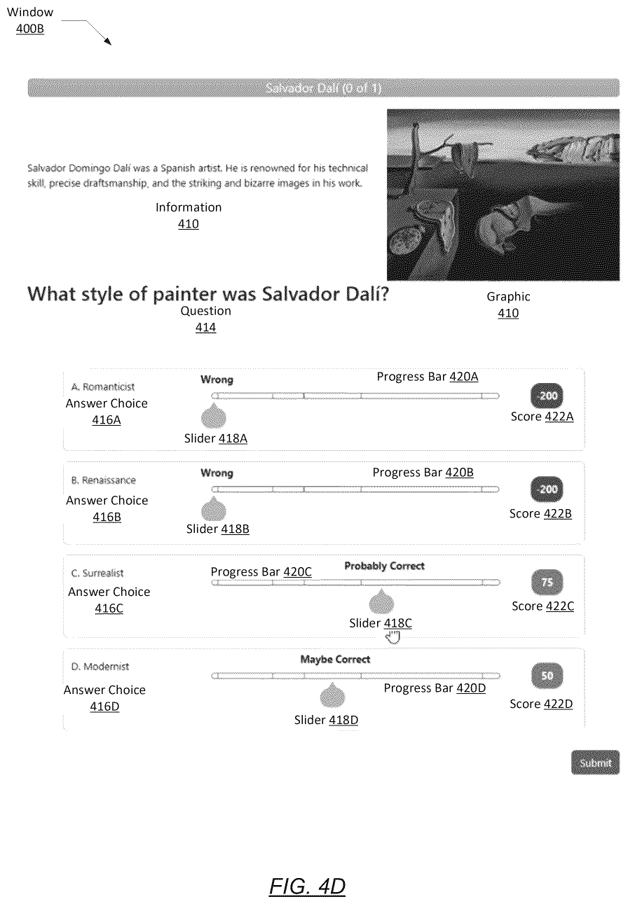

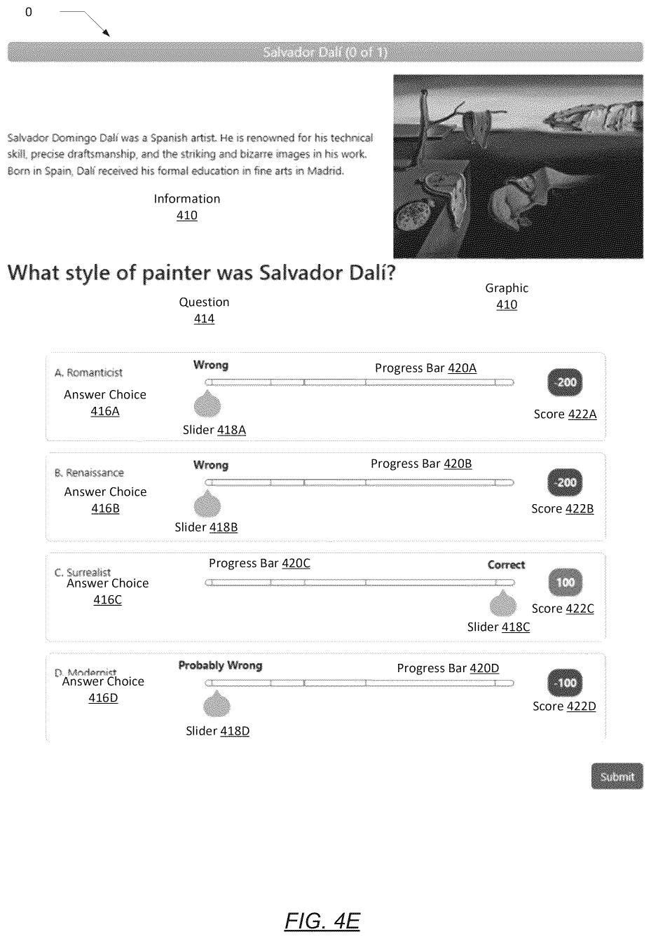

Referring now to FIG. 4, a graphical user interface is shown according to one or more illustrative embodiments. Graphic user interface (400) is one example of graphic user interface (GUI) (140) of FIG. 1, displaying one of question(s) (122) with associated answer choice(s) (124). This GUI integrates with other system components, such as the evaluation engine (150) of FIG. 1, which uses the normalized confidence values to calculate the weighted score (156) for the question presented. This data, reflecting the user's confidence distribution, may be stored as part of the user record(s) (130) within the data repository (110), both illustrated in FIG. 1.

In this example, graphic user interface (400) presents static content, including information (410), graphic (412), and question (414). This static content is not directly manipulated by the slider code. Rather, the static content offers background information for users to interact meaningfully with the sliders. In this example, information (410) and graphic (412) provide a relevant textual description and associated image that provide context for the question (414).

In this example, the question (414) asks, “What kind of painter was Salvador Dalí?” followed by four answer choices (416A, 416B, 416C, and 416D). Each of the answer choices (e.g., Romanticist, Renaissance, Surrealist, Modernist) represents an answer for the question.

Each answer choice is associated with a corresponding one of sliders (418A, 418B, 418C, and 418D), which the user manipulates to express their confidence in the given answer. Visual elements like the handle position, progress bar, and associated badge are updated accordingly.

The sliders (418A, 418B, 418C, and 418D) are interactive elements that allow users to express their confidence in the corresponding answer choices (416A, 416B, 416C, and 416D). The sliders are examples of confidence slider(s) (144) of FIG. 1. While four sliders are shown in this example, it should be understood that any number of sliders can be utilized. For example, graphic user interface (400) may present a plurality of sliders that includes 2, 3, 4, 6, 10, or any other number of sliders that are appropriate to the application.

Each slider is initialized with a default value (i.e., 25%), with corresponding handle position along the progress bars (420A, 420B, 420C, and 420D). For example, when rendered in JavaScript, the sliders can be initialized as:

handle.css(″left″, track.width( ) * 0.25);
valueInput.val(25);
progressBar.attr(′style′, ′width:25%′);

The sliders can be dragged, for example using either touch or mouse. The starting position (startX) and limits (maxLeft) are calculated based on the slider track dimensions. Event listeners manage user interactions (i.e., dragging), tracking and updating the sliders manage position. For example, when rendered in JavaScript:

javascript
Copy code
handle.css(″left″, newLeft + ″px″);

The current slider value is stored in a hidden input (.slider-value) and updated dynamically during dragging:
valueInput.val(value);

FIG. 4B illustrates how the interactive slider system dynamically adapts to the resizing of the window presenting graphic user interface (400). The window has been resized, impacting the layout and proportions of the sliders and progress bars.

The JavaScript code dynamically recalculates and updates the slider handle positions and progress bar widths to fit the resized window while preserving the user input (values). Static elements such as the question, information, and scores remain unaffected, as those elements are not tied to the resizing logic, thus ensuring a consistent user experience regardless of window dimensions.

Event listeners manage the resize event on the window object. For example, when rendered in JavaScript:

```
window.addEventListener(′resize′, function( ) {
  $(″.slider″).each(function( ) {
  // Code to recalculate handle position and progress bar width
  });
});
```

During resizing, the slider-value (currentValue) remains unchanged, preserving the user's previous selections while updating the visual elements. However, progress bar widths are dynamically updated based on the percentage value (currentValue) relative to the resized track width. Each slider recalculates the handle's position and progress bar width based on the new track width during resizing:

var newLeft = (current Value / 100) * track.width( );
handle.css(″left″, newLeft + ″px″);
progressBar.attr(′style′, ′width:′ + currentValue + ′%;′);

In FIG. 4C, the Slider (418B) and Slider (418C) have been manipulated, resulting in updates to the interactive elements in the UI.

The handle for Slider (418B) has been moved to the far left, representing a low confidence level. The handle for Slider (418C) has been moved to the right, representing a higher confidence level. The handle positions are dynamically updated based on the slider's value:

$$handle . css ( “ left ” , newLeft + “ px ” ) ;$$

When the handle's position is updated, the progress bar labels, handle colors, in scores (422 A, 422 B, 422 C and 422D) are updated by an appropriate code function based on the current value of the handle position. The function assigns the appropriate text label (e.g., “Probably Wrong,” “Wrong,” “Probably Correct,” “Correct,” etc. . . . ) based on the current slider value:

Based on the low value of slider (418B), the progress bar (420 B), sometimes referred to as a “response continuum”, is assigned the label “Wrong.” Similarly, the progress bar (420) now reads “Probably Correct.” In some embodiments, the color of the progress bar may change. The colorization of the progress bar may be customized, with each confidence level represented by a corresponding color change.

The scores (422 A, 422 B, 422 C and 422D) are determined based on the slider's value. The scores are calculated dynamically and displayed alongside the progress bar. The score for Slider (418B) has been updated to −200, reflecting an exceptionally low confidence level. The score for Slider (418C) has been updated to 75, reflecting a high confidence level.

The sliders operate on a normalization principle, ensuring that when the confidence level on one slider is adjusted, the others adjust accordingly to maintain a constant confidence sum across all options. This mechanism ensures that a user's overall confidence is distributed proportionally among the answer choices, ensuring an accurate reflection of the user's knowledge and certainty.

For example, if a user is completely confident in one answer, the user might set that slider to the maximum value, which would automatically reduce the values on the other three sliders to zero, maintaining the total confidence sum of 100. Conversely, if a user is unsure and wants to distribute their confidence, the user might adjust the sliders to different values across the answers, with the system automatically recalculating and normalizing the values to maintain the total.

Values of Both sliders (418A and 418D) are dynamically updated to compensate for the increased values of sliders (418B and 418C). When the values of sliders (418B and 418C) are updated, the remaining value is redistributed proportionally among the other sliders (418A and 418D) that can still move, ensuring the total remains 100%.

However, the code redistributes the remaining value only to sliders with a current value >0. If a slider reaches its lower limit (0), it stops adjusting, and the remaining value is shared among the other movable sliders.

if (can_move > 0) {
total_movable_sliders++;
}
newOtherValue = otherCurrentValue + remaining Value /
total_movable_sliders;

The total value across all sliders equals 100%. If the total value of the sliders exceeds or falls short of 100%, the code recalculates the values for other sliders (418A and 418D) to maintain the total.

var totalValue = 0;
$(″.slider″).each(function( ) {
total Value += parseFloat($(this).find(″.slider-value″).val( ));
});
var remaining Value = 100 - totalValue;

The labels are updated to “Probably Wrong” based on the updated values for sliders (418A and 418D). The progress bars (420 A and 420D) are adjusted, and the scores (422A and 422D) are updated to reflect the new reduced value.

The new values for sliders (418A and 418D) are calculated based on the remaining value after changes to sliders (418B and 418C), with the new values constrained to stay between 0 and 100. For example:

var newOtherValue = otherCurrentValue + remaining Value /
total_movable_sliders;
newOtherValue = Math.max(0, Math.min(newOtherValue, 100));

The handle position of sliders (418A and 418D) and the progress bars (420 A and 420D) are updated. The score and text labels are updated based on the new value.

otherHandle.css(″left″, (track.width( ) / 100) * newOtherValue + ″px″);
otherProgressBar.attr(′style′, ′width:′ + newOther Value + ′%;′);
otherReport.html(score);
otherHandleTitle.html(colors.barText);

In FIG. 4D, the sliders dynamically adjust to reflect further user interactions. Slider (418A) retains a minimal value, displaying the label “Wrong” with a score of −200 and an empty progress bar. Slider (418B) also remains unchanged, maintaining its low value and the same label and score as in the previous figure. Slider (418C) continues to reflect a high confidence level, labeled “Probably Correct” with a score of 75 and a full progress bar. Slider (418D), however, increases in value, now labeled “Maybe Correct” with a score of 50 and a wider progress bar. These updates are driven by the code's logic, which redistributes the total slider values to ensure the values sum to 100%, dynamically updating progress bars, labels, and scores based on the user's adjustments.

In FIG. 4E, further manipulation of the sliders has led to additional dynamic updates. Slider (418A) remains at a low value, labeled “Wrong,” with a score of −200 and an almost empty progress bar. Similarly, Slider (418B) also retains a minimal value with the same label and score as before, maintaining its “Wrong” status and reflecting no change in user input. Slider (418C) now shows a maximum confidence level, labeled “Correct,” with a score of 100 and a completely filled progress bar, indicating user selection of this as the most confident choice. Slider (418D), however, has been reduced in value, now labeled “Probably Wrong” with a score of −100 and a narrower progress bar. These changes reflect the JavaScript code's logic for proportional redistribution of values, ensuring that the total across all sliders equals 100%. The updates dynamically adjust the labels, scores, and progress bar widths in response to the user's input while maintaining a responsive and interactive interface.

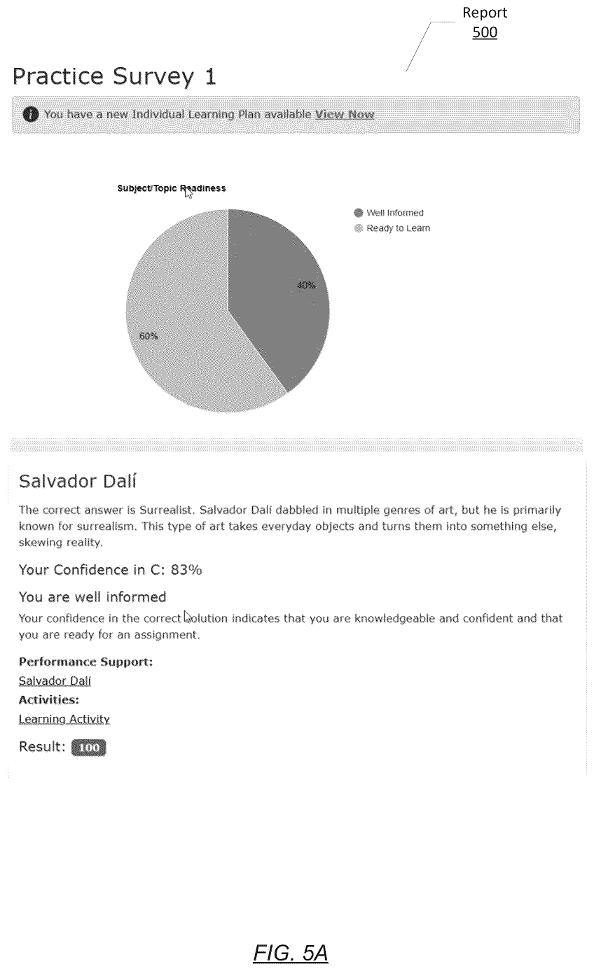

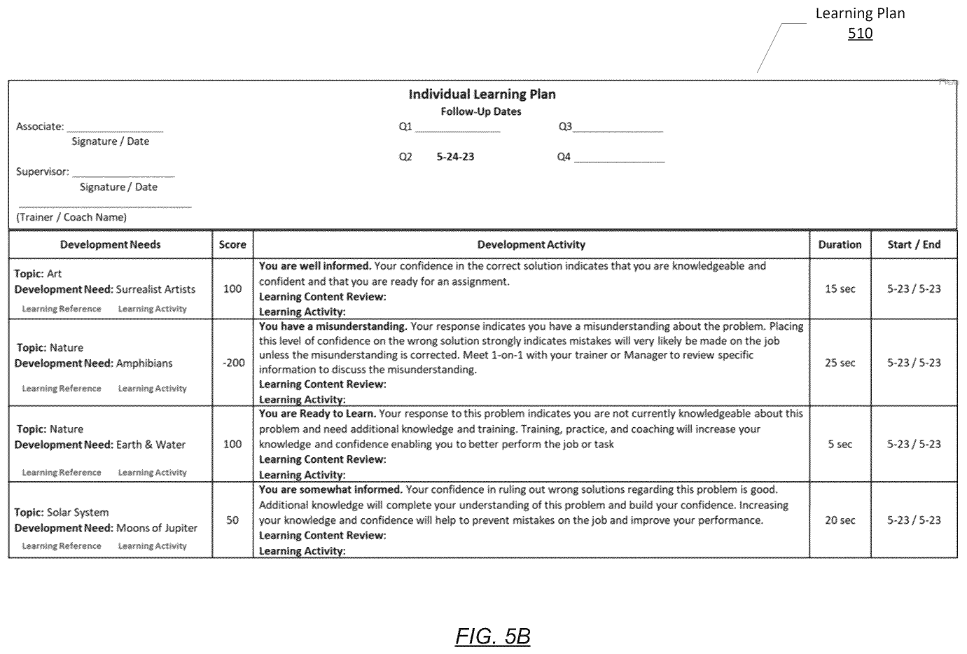

Referring now to FIGS. 5A and 5B, a report is shown according to one or more illustrative embodiments. The report illustrated in FIG. 5 is one example of report(s) (132) of FIG. 1. The graphical and textual elements of the report serve to support decision-making processes for both users and administrators, ensuring effective and targeted employee development.

As illustrated FIG. 5A, the report (500) is generated by the user evaluation system following the completion of an evaluation module. As illustrated, the report is divided into multiple sections to provide a comprehensive assessment of the user's knowledge, confidence levels, and readiness for further learning.

A visualization of Subject/Topic Readiness is shown as a pie chart that quantifies the user's readiness across two dimensions: “Well Informed” (green) and “Ready to Learn” (yellow). The example demonstrates a distribution where 40% of the user's responses are classified as “Well Informed,” and 60% fall under “Ready to Learn.”

Beneath the chart, a detailed section focuses on a specific question in the training module. For example, as illustrated the correct answer is identified as “Surrealist,” accompanied by contextual information about Dalí's contributions to surrealism. The system assesses the user's confidence in selecting the correct answer (“C”), shown as 83%, and classifies the user as “Well Informed.”

Performance Support and Learning Activities provide targeted resources for further engagement. For example, under “Performance Support,” related content about Salvador Dalí is referenced. The “Activities” section suggests a “Learning Activity” designed to reinforce or expand the user's knowledge.

Referring now to FIG. 5B, the individual learning plan documenting an employee's knowledge and confidence levels across different topics. The report records scores, development needs, and suggested learning activities. High scores reflect well-informed areas, while negative scores indicate misunderstandings, prompting recommendations for further review or training. The report includes sections for associate and supervisor signatures, reinforcing its use as a formal assessment tool within an organization's learning and development framework.

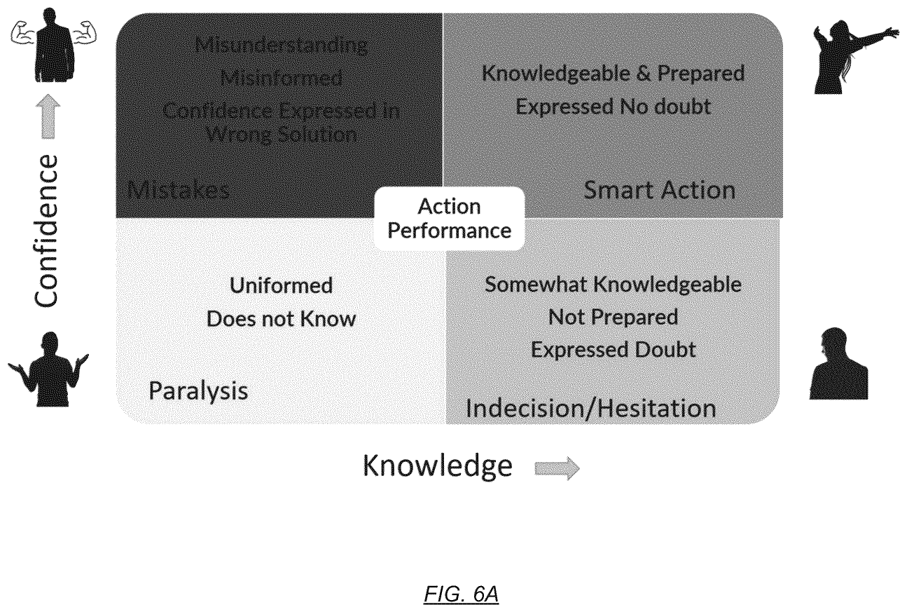

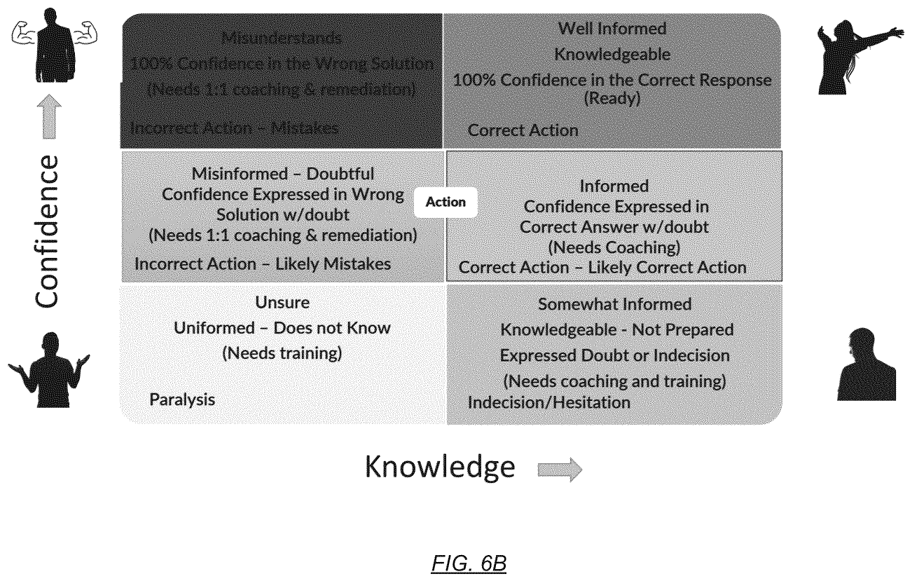

Referring now to FIG. 6A, a quantized categorization is shown according to one or more illustrative embodiments. Quantized categorization can be performed as part of generating report(s) (132) of FIG. 1.

The quantized categorization chart can be used to evaluate a user's performance based on two axes: Knowledge and Confidence. In this example, the charts depicts four distinct quadrants each representing a combination of these attributes. Descriptors for the behaviors or performance levels typically associated with each quadrant are also illustrated. The chart may be color-coded and may feature silhouetted figures that correspond to various levels of knowledge and confidence, such as a figure shrugging in the low knowledge-low confidence quadrant or celebrating in the high knowledge-high confidence quadrant. The visualization provided in the quartile categorization chart may aide in assessing where a learner falls within the spectrum of understanding and self-assurance in their skills or knowledge.

FIG. 6B illustrates a second example of a quantized categorization, according to one or more illustrative embodiments. In this example, the chart displays 6 categorizations, each corresponding to a different combination of the confidence and knowledge. As compared to FIG. 6A, FIG. 6B introduces additional categorizations along the confidence axis, showing an intermediate level of confidence. Appropriate descriptors and color coding may also be employed to aide in assessing where a learner falls within the spectrum of understanding and self-assurance in their skills or knowledge.

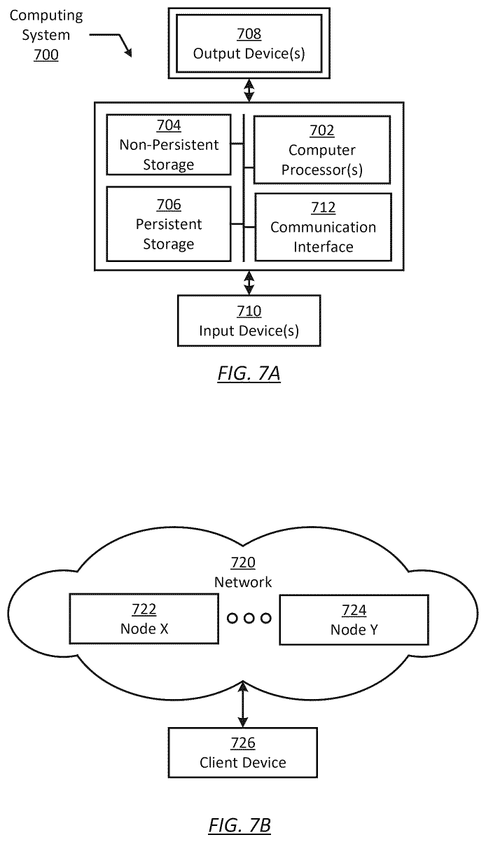

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 7A, the computing system (700) may include one or more computer processors (702), non-persistent storage (704), persistent storage (706), a communication interface (712) (e.g., Bluetooth interface, infrared interface, network interface, optical interface, etc.), and numerous other elements and functionalities that implement the features and elements of the disclosure. The computer processor(s) (702) may be an integrated circuit for processing instructions. The computer processor(s) may be one or more cores or micro-cores of a processor. The computer processor(s) (702) includes one or more processors. The one or more processors may include a central processing unit (CPU), a graphics processing unit (GPU), a tensor processing unit (TPU), combinations thereof, etc.

The input devices (710) may include a touchscreen, keyboard, mouse, microphone, touchpad, electronic pen, or any other type of input device. The input devices (710) may receive inputs from a user that are responsive to data and messages presented by the output devices (708). The inputs may include text input, audio input, video input, etc., which may be processed and transmitted by the computing system (700) in accordance with the disclosure. The communication interface (712) may include an integrated circuit for connecting the computing system (700) to a network (not shown) (e.g., a local area network (LAN), a wide area network (WAN) such as the Internet, mobile network, or any other type of network) and/or to another device, such as another computing device.

Further, the output devices (708) may include a display device, a printer, external storage, or any other output device. One or more of the output devices may be the same or different from the input device(s). The input and output device(s) may be locally or remotely connected to the computer processor(s) (702). Many diverse types of computing systems exist, and the aforementioned input and output device(s) may take other forms. The output devices (708) may display data and messages that are transmitted and received by the computing system (700). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention, which may include transmitting, receiving, presenting, and displaying data and messages described in the other figures of the disclosure.

The computing system (700) in FIG. 7A may be connected to or be a part of a network. For example, as shown in FIG. 7B, the network (720) may include multiple nodes (e.g., node X (722), node Y (724)). Each node may correspond to a computing system, such as the computing system shown in FIG. 7A, or a group of nodes combined may correspond to the computing system shown in FIG. 7A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (700) may be located at a remote location and connected to the other elements over a network.

The nodes (e.g., node X (722), node Y (724)) in the network (720) may be configured to provide services for a client device (726), including receiving requests and transmitting responses to the client device (726). For example, the nodes may be part of a cloud computing system. The client device (726) may be a computing system, such as the computing system shown in FIG. 7A. Further, the client device (726) may include and/or perform all or a portion of one or more embodiments of the invention.

The computing system of FIG. 7A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the term “or” is an “inclusive or” and, as such includes the term “and.” Further, items joined by the term “or” may include any combination of the items with any number of each item unless, expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method for performing a user evaluation, the method comprising:
retrieving an evaluation module from a data repository, the evaluation module comprising a set of questions;
presenting a question with a number of answer choices in a graphic user interface, wherein each answer choice is associated with a respective confidence slider, wherein each confidence slider is operable to receive an input representing a user's confidence in an associated answer choice;
for each answer choice, generating a confidence factor based on a position of the respective confidence slider for the associated answer choice;
calculating a weighted score for the question by scaling a question score by the confidence factor associated with a correct answer to the question; and
generating a report based on the weighted score and the confidence factor associated with the correct answer.

2. The method of claim 1, wherein generating the confidence factor for each answer choice further comprises:
normalizing confidence factors across the number of answer choices based on relative positions of each confidence slider.

3. The method of claim 1, further comprising:
presenting a sequence of questions selected from the set of questions;
calculating weighted scores for each respective question in the sequence of questions; and
calculating a combined score for the evaluation module based on a combination of the weighted scores for the set of questions, wherein the combined score represents a user's overall mastery of subject matter in the evaluation module.

4. The method of claim 3, wherein calculating the combined score further comprises:
at each respective step of the sequence, incrementing the combined score based on the weighted score calculated for an associated question; and
adjusting presentation of subsequent questions in the evaluation module based on the combined score, wherein the adjusting includes at least one of: modifying question difficulty, reordering questions in the sequence, and adjusting the number of answer choices presented in the graphic user interface.

5. The method of claim 1, wherein generating the report further comprises:
generating a quartile categorization of the confidence factor associated with the correct answer to the question; and
presenting the quartile categorization in a chart displayed in the graphical user interface.

6. The method of claim 1, wherein generating the report further comprises:
providing recommendations for further training based on a set of user records stored in the data repository, wherein the recommendation comprises one or more additional modules based on a user's demonstrated knowledge and confidence levels as indicated in the report.

7. The method of claim 1, further comprising:
storing the report in the data repository as part of a set of user records, including at least one of: user demographics, job role, performance metrics, and training history.

8. The method of claim 1, further comprising:
generating real-time analytics based on the weighted score, the confidence factor and a set of user records stored in the data repository to assess effectiveness of the evaluation module; and
displaying the real-time analytics in the graphic user interface to support decision-making processes related to employee training and development.

9. The method of claim 1, further comprising:
receiving, additional content, including at least one of text, images, and multimedia; and
inputting the additional content and the set of user records to a large language model,
automatically generating additional evaluation modules from the additional content, wherein the additional evaluation modules are tailored to a user's demonstrated knowledge and confidence levels as indicated in the set of user records.

10. An employee evaluation system, comprising:
a processor;
a data repository storing one or more training modules, wherein each of the training modules comprises a respective set of questions, and
a non-transitory memory coupled to the processor, the non-transitory memory storing instructions that, when executed by the processor, cause the employee evaluation system to perform the method of:
retrieving an evaluation module from a data repository, the evaluation module comprising a set of questions;
presenting a question with a number of answer choices in a graphic user interface, wherein each answer choice is associated with a respective confidence slider, wherein each confidence slider is operable to receive an input representing a user's confidence in an associated answer choice;
for each answer choice, generating a confidence factor based on a position of the respective confidence slider for the associated answer choice;
calculating a weighted score for the question by scaling a question score by the confidence factor associated with a correct answer to the question; and
generating a report based on the weighted score and the confidence factor associated with the correct answer.

11. The employee evaluation system of claim 10, wherein generating the confidence factor for each answer choice further comprises:
normalizing confidence factors across the number of answer choices based on relative positions of each confidence slider.

12. The employee evaluation system of claim 10, further comprising:
presenting a sequence of questions selected from the set of questions;
calculating weighted scores for each respective question in the sequence of questions; and
calculating a combined score for the evaluation module based on a combination of the weighted scores for the set of questions, wherein the combined score represents a user's overall mastery of subject matter in the evaluation module.

13. The employee evaluation system of claim 10, wherein calculating the combined score further comprises:
at each respective step of the sequence, incrementing the combined score based on the weighted score calculated for an associated question; and
adjusting presentation of subsequent questions in the evaluation module based on the combined score, wherein the adjusting includes at least one of: modifying question difficulty, reordering questions in the sequence, and adjusting the number of answer choices presented in the graphic user interface.

14. The employee evaluation system of claim 10, wherein generating the report further comprises:
generating a quartile categorization of the confidence factor associated with the correct answer to the question; and
presenting the quartile categorization in a chart displayed in the graphical user interface.

15. The employee evaluation system of claim 10, wherein generating the report further comprises:
providing recommendations for further training based on a set of user records stored in the data repository, wherein the recommendation comprises one or more additional modules based on a user's demonstrated knowledge and confidence levels as indicated in the report.

16. A computer program product, comprising:
a non-transitory memory storing instructions that, when executed by a processor, cause a computer system to perform the method of:
retrieving an evaluation module from a data repository, the evaluation module comprising a set of questions;
presenting a question with a number of answer choices in a graphic user interface, wherein each answer choice is associated with a respective confidence slider, wherein each confidence slider is operable to receive an input representing a user's confidence in an associated answer choice;
for each answer choice, generating a confidence factor based on a position of the respective confidence slider for the associated answer choice;
calculating a weighted score for the question by scaling a question score by the confidence factor associated with a correct answer to the question; and
generating a report based on the weighted score and the confidence factor associated with the correct answer.

17. The computer program product of claim 16, wherein generating the confidence factor for each answer choice further comprises:
normalizing confidence factors across the number of answer choices based on relative positions of each confidence slider.

18. The computer program product of claim 16, further comprising:
presenting a sequence of questions selected from the set of questions;
calculating weighted scores for each respective question in the sequence of questions; and
calculating a combined score for the evaluation module based on a combination of the weighted scores for the set of questions, wherein the combined score represents a user's overall mastery of subject matter in the evaluation module.

19. The computer program product of claim 16, wherein calculating the combined score further comprises:
at each respective step of the sequence, incrementing the combined score based on the weighted score calculated for an associated question; and
adjusting presentation of subsequent questions in the evaluation module based on the combined score, wherein the adjusting includes at least one of: modifying question difficulty, reordering questions in the sequence, and adjusting the number of answer choices presented in the graphic user interface.

20. The computer program product of claim 16, wherein generating the report further comprises:
generating a quantized categorization of the confidence factor associated with the correct answer to the question;
presenting the quantized categorization in a chart displayed in the graphical user interface; and
providing recommendations for further training based on a set of user records stored in the data repository, wherein the recommendation comprises one or more additional modules based on a user's demonstrated knowledge and confidence levels as indicated in the report.
